(19) United States
(12) Patent Application Publication
(10) Pub. No.: US 2024/0284348 A1
(43) Pub. Date: Aug. 22, 2024

(54) Method And Apparatus For Network Energy Saving In Power Domain In Mobile Communications

(71) Applicant: MediaTek Inc., Hsinchu City (TW)

(72) Inventors: Chi-Hsuan Hsieh, Hsinchu City (TW); Wei-De Wu, Hsinchu City (TW)

(21) Appl. No.: 18/424,926

(22) Filed: Jan. 29, 2024

Related U.S. Application Data
(60) Provisional application No. 63/485,568, filed on Feb. 17, 2023.

(51) Int. Cl. H04W 52/36; H04B 7/06; H04W 24/10; H04W 72/1273; H04W 72/231; H04W 76/20

(52) U.S. Cl. CPC H04W 52/36; H04B 7/0626; H04B 7/0632; H04W 24/10; H04W 72/1273; H04W 72/231; H04W 76/20

(57) ABSTRACT

Examples pertaining to network energy saving in power domain in mobile communications are described. A user equipment (UE) receives a report configuration from a network apparatus. The report configuration includes a list of sub-configurations which associates with a plurality of power offset values configured by the network apparatus. Then, the UE transmits one or more measurement reports generated based on the power offset values.

### CROSS REFERENCE TO RELATED PATENT APPLICATION(S)

The present disclosure is part of a non-provisional application claiming the priority benefit of U.S. Patent Application No. 63/485,568, filed 17 Feb. 2023, the content of which herein being incorporated by reference in its entirety.

### TECHNICAL FIELD

The present disclosure is generally related to mobile communications and, more particularly, to network energy saving techniques in power domain with respect to user equipment and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Considering of this, how to achieve network energy saving becomes an important issue for the newly developed wireless communication network. Therefore, there is a need to provide proper schemes for network energy saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to network power saving with respect to user equipment (UE) and network apparatus (e.g., a network node or a base station (BS), such as a next generation Node B (gNB)) in mobile communications.

In one aspect, a method may involve a communication apparatus receiving a report configuration from a network node and transmitting one or more measurement reports generated based on the power offset values. The report configuration comprises a list of sub-configurations which associates with a plurality of power offset values configured by the network apparatus.

In one aspect, a communication apparatus may involve a transceiver which, during operation, wirelessly communicates with at least one network apparatus. The communication apparatus may also involve a processor communicatively coupled to the transceiver such that, during operation, the processor performs following operations: receiving, via the transceiver, a report configuration from the network apparatus; and transmitting, via the transceiver, one or more measurement reports generated based on the power offset values. The report configuration comprises a list of sub-configurations which associates with a plurality of power offset values configured by the network apparatus.

In one aspect, a method may involve a network apparatus determining at least one power offset value for a communication apparatus and transmitting a report configuration to the communication apparatus. The report configuration comprises at least one sub-configuration associating with the power offset value.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of several power offsets under schemes in accordance with implementations of the present disclosure.

FIG. 2 is a diagram depicting an example format of an NZP-CSI-RS resource configuration under schemes in accordance with implementations of the present disclosure.

FIG. 3 is a diagram depicting an example scenario of a CSI report configuration message flow under schemes in accordance with implementations of the present disclosure.

FIG. 4 is a diagram depicting an example communication system having an example communication apparatus and an example network apparatus in accordance with an implementation of the present disclosure.

FIG. 5 is a diagram depicting an example process in accordance with an implementation of the present disclosure.

FIG. 6 is a diagram depicting another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to adaptation in power domain for network energy saving. According to the present disclosure, a number of possible solutions may be implemented separately or jointly. That is, although these possible solutions may be described below separately, two or more of these possible solutions may be implemented in one combination or another.

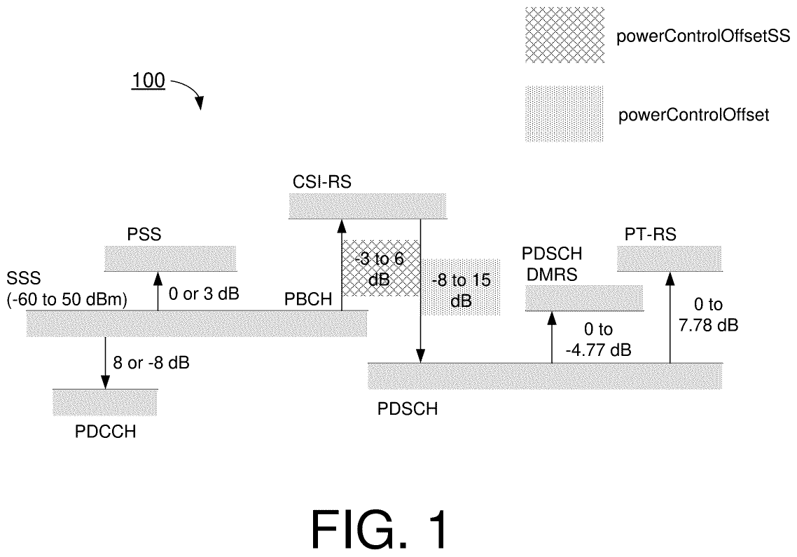

FIG. 1 illustrates an example scenario 100 of different power offsets under schemes in accordance with implementations of the present disclosure. Scenario 100 involves a network apparatus and a UE, which may be a part of a wireless communication network (e.g., an LTE network, a 5G/NR network, an IoT network or a 6G network). The network apparatus may determine the downlink transmit power, e.g., the energy per resource element (EPRE), for the UE. The network apparatus may first indicate the downlink transmit power of synchronization signal (SS) and physical broadcast channel (PBCH) block (i.e., SSB) in a master information block (MIB) or a system information block (SIB).

The UE may derive the downlink channel state information-reference signal (CSI-RS) EPRE from the SS/PBCH block downlink transmit power and CSI-RS power offset given by the parameter powerControlOffsetSS provided by higher layers. Referring to FIG. 1, the parameter powerContolOffsetSS may indicate a value in the range of [−3, 6] dB. The parameter powerContolOffset is the assumed ratio of physical downlink shared channel (PDSCH) EPRE to non-zero power (NZP) CSI-RS EPRE when UE derives CSI feedback and may indicate a value in the range of [−8, 15] dB.

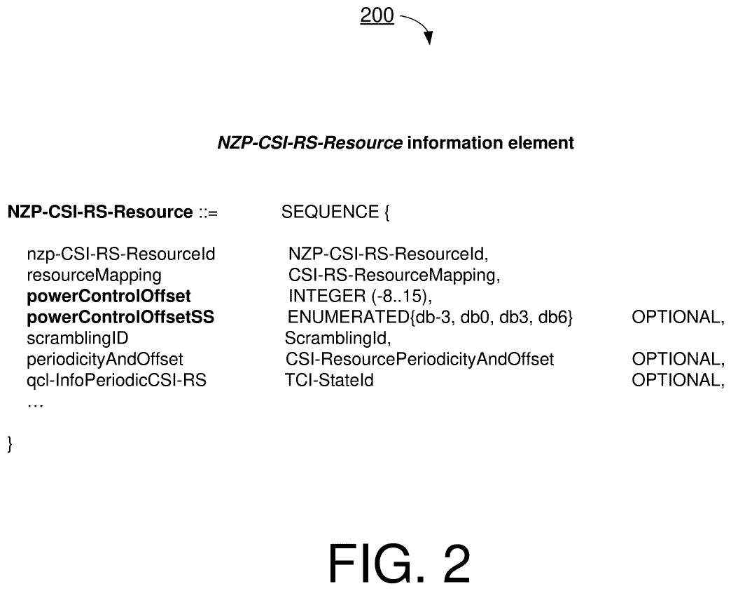

FIG. 2 illustrates an example format 200 of an NZP-CSI-RS resource configuration under schemes in accordance with implementations of the present disclosure. In some embodiments, the powerControlOffsetSS information element (IE) and the powerControlOffset IE may be configured in the NZP-CSI-RS resource configuration through the radio resource control (RRC) signaling. The UE may receive the CSI resource configuration CSI-ResourceConfig from the network apparatus. The CSI resource configuration CSI-ResourceConfig may comprise the NZP-CSI-RS resources and downlink power offsets used to configure downlink power for the CSI-RS and the PDSCH, such as the aforementioned IEs powerContolOffset and powerContolOffsetSS.

In addition to the CSI resource configuration, in some embodiments, the UE may further receive a report configuration from the network apparatus. In some embodiments, the report configuration may be received from the network apparatus through an RRC signaling. The report configuration may comprise a list of sub-configurations which associates with a plurality of power offset values configured by the network apparatus.

In some embodiments, each sub-configuration may be identified by a corresponding identity and may correspond to one power offset value, and the power offset values may be the configurable values of a predetermined power offset. As an example, but not limited to, the predetermined power offset may be the aforementioned power offset parameters powerContolOffset or powerContolOffsetSS.

In some embodiments, multiple values of power offset parameter powerContolOffset or powerContolOffsetSS (e.g., multiple powerContolOffset or multiple powerContolOffsetSS) may be configured, and the list of sub-configurations indicated in the report configuration may be an implementation of configuring multiple powerContolOffset or powerContolOffsetSS.

In some embodiments, the network apparatus may determine at least one power offset value for the communication apparatus and transmit the report configuration to the communication apparatus. The report configuration may comprise at least one sub-configuration associating with the power offset value.

In some embodiments, each of the power offset values may comprise a power offset for a PDSCH relative to a CSI-RS, such as the power offset parameter powerContolOffset. In some embodiments, each of the power offset values may comprise a power offset for a CSI-RS relative to a SS/PBCH block, such as the power offset parameter powerContolOffsetSS.

In some embodiments, the UE may measure the CSI-RS to determine one or more CSI parameters, which may be qualities related to the state of the channel, based on at least one of the power offset values. In some embodiments, the UE may generate one or more measurement reports according to the one or more CSI parameters, to report the CSI parameters to the network apparatus as the CSI feedback.

In some embodiments, the UE may transmit said one or more measurement reports generated based on the power offset values to the network apparatus. In some embodiments, the power offset values may be configured by the network apparatus for channel quality indicator (CQI) calculation, and the UE may determine a CQI according to at least one of the power offset values.

As an exemplary implementation, the UE may assume the corresponding PDSCH signals transmitted on the antenna ports of a CSI-RS resource would have a ratio of EPRE to CSI-RS EPRE equal to the difference between powerControlOffset of the CSI-RS resource and the power offset value, where the difference is expected to take one of the values that can be configured for powerControlOffset of the CSI-RS resource, and is also expected to take a value that is no larger than the value of powerControlOffset.

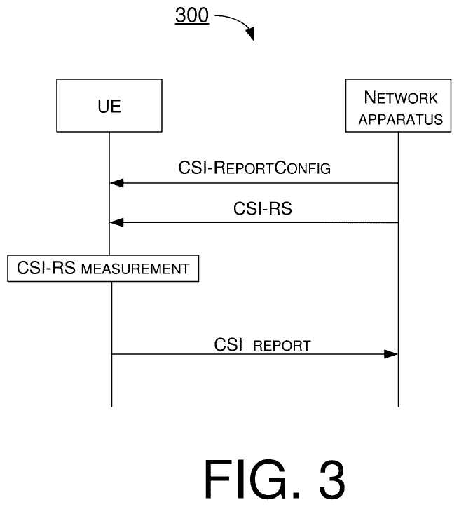

FIG. 3 illustrates an example scenario 300 of a CSI report configuration message flow under schemes in accordance with implementations of the present disclosure. Scenario 300 involves the network apparatus and the UE transmitting messages therebetween. Referring to FIG. 3, the UE may receive a CSI report (re)configuration (e.g., CSI-ReportConfig) from the network apparatus through RRC.

After the CSI report (re)configuration has been applied, the UE may receive the CSI-RS at the CSI-RS occasion(s) to perform the CSI-RS measurement, and accordingly determine one or more CSI parameters. The UE may report at least one CSI report based on the one or more CSI parameters.

In some embodiments, the network apparatus may perform adaptation in power domain according to said one or more measurement reports generated by the UE based on the power offset values. For example, the network apparatus may determine a sufficient downlink power for the PDSCH or the CSI-RS with less power consumption.

In some embodiments, the network apparatus may use a downlink control information (DCI) or a media access control (MAC) control element (MAC-CE) to indicate which elements in the multiple powerControlOffset or powerControlOffsetSS (or which subsets) should be reported in measurement report, such as the CSI report. In some embodiments, the indication may be based on a cell-wise signal, e.g., a paging signal, or a paging early indication (PEI), or a system information block (SIB) based signal.

In some embodiments, the UE may receive an indication to select one or more of the sub-configurations from the network apparatus via a DCI or a MAC-CE. In some embodiments, one or more trigger states may be configured with each indicating one or more of the sub-configurations. In some embodiments, a trigger state corresponding to said one or more of the sub-configurations is initiated using a CSI request field in the DCI.

In some embodiments, for CSI (e.g., aperiodic CSI (A-CSI) or semi-persistent CSI (SP-CSI)) on physical uplink shared channel (PUSCH) report, a DCI-based triggering may be supported. In some embodiments, for CSI (e.g., SP-CSI) on physical uplink control channel (PUCCH) report, a MAC-CE-based triggering may be supported.

### Illustrative Implementations

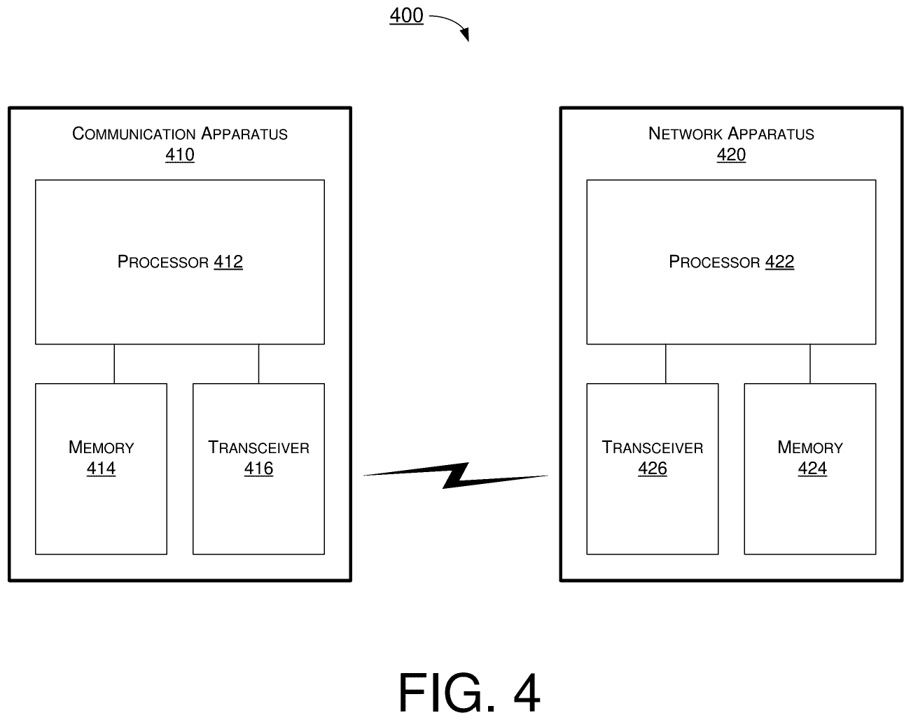

FIG. 4 illustrates an example communication system 400 having an example communication apparatus 410 and an example network apparatus 420 in accordance with an implementation of the present disclosure. Each of the communication apparatus 410 and the network apparatus 420 may perform various functions to implement schemes, techniques, processes and methods described herein pertaining to network power or energy saving with respect to user equipment and network apparatus in mobile communications, including scenarios/schemes described above as well as the process 500 and the process 600 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The network apparatus 420 may be a part of a network device, which may be a network node such as a satellite, a base station, a small cell, a router or a gateway. For instance, the network apparatus 420 may be implemented in an eNodeB in an LTE network, in a gNB in a 5G/NR, IoT, NB-IoT or IIoT network or in a satellite or base station in a 6G network. Alternatively, the network apparatus 420 may be implemented in the form of one or more IC chips such as, for example and without limitation, one or more single-core processors, one or more multi-core processors, or one or more RISC or CISC processors. The network apparatus 420 may include at least some of those components shown in FIG. 4 such as a processor 422, for example. The network apparatus 420 may further include one or more other components not pertinent to the proposed scheme of the present disclosure (e.g., internal power supply, display device and/or user interface device), and, thus, such component(s) of the network apparatus 420 are neither shown in FIG. 4 nor described below in the interest of simplicity and brevity.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks including autonomous reliability enhancements in a device (e.g., as represented by communication apparatus 410) and a network (e.g., as represented by network apparatus 420) in accordance with various implementations of the present disclosure.

In some implementations, the communication apparatus 410 may also include a transceiver 416 coupled to the processor 412 and capable of wirelessly transmitting and receiving data. In some implementations, the communication apparatus 410 may further include a memory 414 coupled to the processor 412 and capable of being accessed by the processor 412 and storing data therein. In some implementations, the network apparatus 420 may also include a transceiver 426 coupled to the processor 422 and capable of wirelessly transmitting and receiving data. In some implementations, the network apparatus 420 may have a plurality of physical antennas which are associated with a plurality of antenna ports. In some implementations, the network apparatus 420 may further include a memory 424 coupled to processor 422 and capable of being accessed by the processor 422 and storing data therein. Accordingly, communication apparatus 410 and the network apparatus 420 may wirelessly communicate with each other via the transceiver 416 and the transceiver 426, respectively. To aid better understanding, the following description of the operations, functionalities and capabilities of each of the communication apparatus 410 and the network apparatus 420 is provided in the context of a mobile communication environment in which the communication apparatus 410 is implemented in or as a communication apparatus or a UE and the network apparatus 420 is implemented in or as a network node or a network device of a communication network.

In some implementations, the processor 412 of the communication apparatus 410 may receive a report configuration from the network apparatus 420 via the transceiver 416. The report configuration may comprise a list of sub-configurations, and the list of sub-configurations associates with a plurality of power offset values configured by the network apparatus 420. In some implementations, the processor 412 may transmit one or more measurement reports generated based on the power offset values to the network apparatus 420 via the transceiver 416.

In some implementations, the processor 412 may determine a CQI according to at least one of the power offset values.

In some implementations, each of the power offset values may comprise a power offset for a PDSCH relative to a CSI-RS.

In some implementations, processor 412 may measure the CSI-RS to determine one or more CSI parameters based on at least one of the power offset values and generate the one or more measurement reports according to the one or more CSI parameters.

In some implementations, the report configuration may be received from the network apparatus 420 through an RRC signaling.

In some implementations, the processor 412 may receive, via the transceiver 416, an indication to select one or more of the sub-configurations from the network apparatus 420 via a DCI or a MAC-CE.

In some implementations, a trigger state corresponding to said one or more of the sub-configurations may be initiated using a CSI request field in the DCI.

In some implementations, the processor 422 of the network apparatus 420 may determine at least one power offset value for the communication apparatus 410. In some implementations, the processor 422 may transmit a report configuration to the communication apparatus 410 via the transceiver 426. The report configuration may comprise at least one sub-configuration associating with the power offset value.

In some implementations, the power offset value may be configured by processor 422 for a CQI calculation.

In some implementations, the power offset value comprises a power offset for a PDSCH relative to a CSI-RS.

In some implementations, the report configuration is transmitted through an RRC signaling.

In some implementations, the processor 422 may transmit, via the transceiver 426, an indication to select the sub-configuration to the communication apparatus 410 via a DCI or a MAC-CE.

In some implementations, a trigger state corresponding to the sub-configuration may be initiated using a CSI request field in the DCI.

### Illustrative Processes

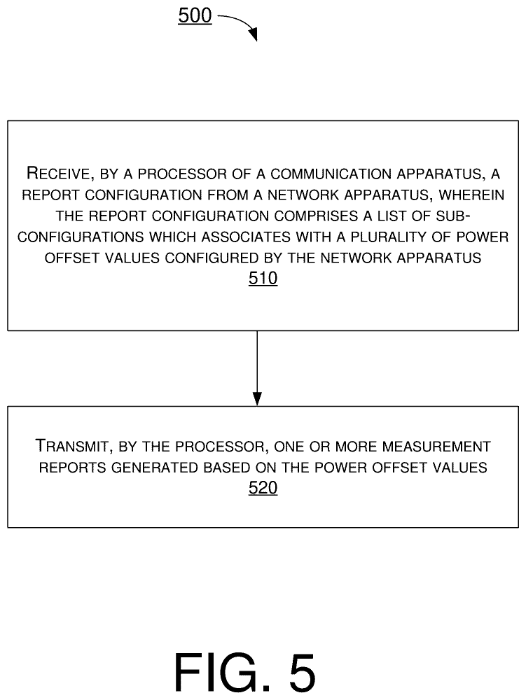

FIG. 5 illustrates an example process 500 in accordance with an implementation of the present disclosure. The process 500 may be an example implementation of above scenarios/schemes, whether partially or completely, with respect to network power saving in power domain with the present disclosure. Process 500 may represent an aspect of implementation of features of the communication apparatus 410. Process 500 may include one or more operations, actions, or functions as illustrated by one or more of blocks 510 and 520. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the communication apparatus 410 or any suitable UE or machine type devices. Solely for illustrative purposes and without limitation, the process 500 is described below in the context of the communication apparatus 410. The process 500 may begin at block 510.

At 510, process 500 may involve the processor 412 of the communication apparatus 410 receiving a report configuration from the network apparatus 420. The report configuration may comprise a list of sub-configurations which associates with a plurality of power offset values configured by the network apparatus 420. The process 500 may proceed from 510 to 520.

At 520, the process 500 may involve processor 412 transmitting one or more measurement reports generated based on the power offset values.

In some implementations, the process 500 may involve the processor 412 determining a CQI according to at least one of the power offset values.

In some implementations, each of the power offset values may comprise a power offset for a PDSCH relative to a CSI-RS.

In some implementations, the process 500 may involve the processor 412 measuring the CSI-RS to determine one or more CSI parameters based on at least one of the power offset values and generating the one or more measurement reports according to the one or more CSI parameters.

In some implementations, the report configuration is received from the network apparatus through an RRC signaling.

In some implementations, process 500 may involve the processor 412 receiving an indication to select one or more of the sub-configurations from the network apparatus via a DCI or a MAC-CE.

In some implementations, a trigger state corresponding to said one or more of the sub-configurations is initiated using a CSI request field in the DCI.

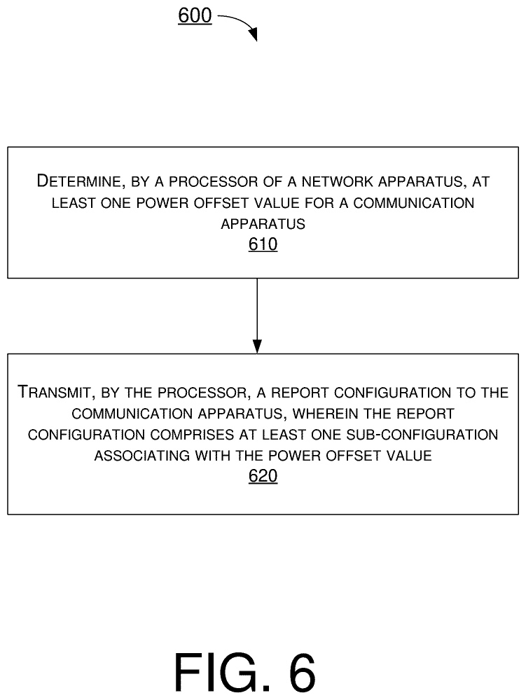

FIG. 6 depicting an example process 600 in accordance with an implementation of the present disclosure. The process 600 may be an example implementation of above scenarios/schemes, whether partially or completely, with respect to network power saving in power domain with the present disclosure. The process 600 may represent an aspect of implementation of features of the network apparatus 420. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by network apparatus 420 or any suitable network device or network node. Solely for illustrative purposes and without limitation, the process 600 is described below in the context of the network apparatus 420. The process 600 may begin at block 610.

At 610, process 600 may involve processor 422 of the network apparatus 420 determining at least one power offset value for the communication apparatus 410. The process 600 may proceed from 610 to 620.

At 620, process 600 may involve processor 422 transmitting a report configuration to the communication apparatus 410. The report configuration may comprise at least one sub-configuration associating with the power offset value.

In some implementations, the power offset value is configured by the network apparatus 420 for CQI calculation.

In some implementations, the power offset value comprises a power offset for a PDSCH relative to a CSI-RS.

In some implementations, the report configuration is transmitted through an RRC signaling.

In some implementations, the process 600 may involve the processor 422 transmitting an indication to select the sub-configuration to the communication apparatus via a DCI or a MAC-CE.

In some implementations, a trigger state corresponding to the sub-configuration may be initiated using a CSI request field in the DCI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a communication apparatus, a report configuration from a network apparatus, wherein the report configuration comprises a list of sub-configurations which associates with a plurality of power offset values configured by the network apparatus; and
transmitting, by the processor, one or more measurement reports generated based on the power offset values.

2. The method of claim 1, further comprising:
determining, by the processor, a channel quality indicator (CQI) according to at least one of the power offset values.

3. The method of claim 1, wherein each of the power offset values comprises a power offset for a physical downlink shared channel (PDSCH) relative to a channel state information-reference signal (CSI-RS).

4. The method of claim 3, further comprising:
measuring, by the processor, the CSI-RS to determine one or more CSI parameters based on at least one of the power offset values; and
generating, by the processor, the one or more measurement reports according to the one or more CSI parameters.

5. The method of claim 1, wherein the report configuration is received from the network apparatus through a radio resource control (RRC) signaling.

6. The method of claim 1, further comprising:
receiving, by the processor, an indication to select one or more of the sub-configurations from the network apparatus via a downlink control information (DCI) or a media access control (MAC) control element (MAC-CE).

7. The method of claim 6, wherein a trigger state corresponding to said one or more of the sub-configurations is initiated using a CSI request field in the DCI.

8. A communication apparatus, comprising:
a transceiver which, during operation, wirelessly communicates with at least one network apparatus; and
a processor communicatively coupled to the transceiver such that, during operation, the processor performs operations comprising:
receiving, via the transceiver, a report configuration from the network apparatus, wherein the report configuration comprises a list of sub-configurations which associates with a plurality of power offset values configured by the network apparatus; and
transmitting, via the transceiver, one or more measurement reports generated based on the power offset values.

9. The communication apparatus of claim 8, wherein, during operation, the processor further performs operations comprising:
determining a channel quality indicator (CQI) according to at least one of the power offset values.

10. The communication apparatus of claim 8, wherein each of the power offset values comprises a power offset for a physical downlink shared channel (PDSCH) relative to a channel state information-reference signal (CSI-RS).

11. The communication apparatus of claim 10, wherein, during operation, the processor further performs operations comprising:
measuring the CSI-RS to determine one or more CSI parameters based on at least one of the power offset values; and
generating the one or more measurement reports according to the one or more CSI parameters.

12. The communication apparatus of claim 8, wherein the report configuration is received from the network apparatus through a radio resource control (RRC) signaling.

13. The communication apparatus of claim 8, wherein, during operation, the processor further performs operations comprising:
receiving, via the transceiver, an indication to select one or more of the sub-configurations from the network apparatus via a downlink control information (DCI) or a media access control (MAC) control element (MAC-CE).

14. The communication apparatus of claim 13, wherein a trigger state corresponding to said one or more of the sub-configurations is initiated using a CSI request field in the DCI.

15. A method, comprising:
determining, by a processor of a network apparatus, at least one power offset value for a communication apparatus; and
transmitting, by the processor, a report configuration to the communication apparatus, wherein the report configuration comprises at least one sub-configuration associating with the power offset value.

16. The method of claim 15, wherein the power offset value is configured by the processor for a channel quality indicator (CQI) calculation.

17. The method of claim 15, wherein the power offset value comprises a power offset for a physical downlink shared channel (PDSCH) relative to a channel state information-reference signal (CSI-RS).

18. The method of claim 15, wherein the report configuration is transmitted through a radio resource control (RRC) signaling.

19. The method of claim 15, further comprising:
transmitting, by the processor, an indication to select the sub-configuration to the communication apparatus via a downlink control information (DCI) or a media access control (MAC) control element (MAC-CE).

20. The method of claim 19, wherein a trigger state corresponding to the sub-configuration is initiated using a CSI request field in the DCI.
